(19) United States
(12) Patent Application Publication
(10) Pub. No.: US 2025/0219062 A1
(43) Pub. Date: Jul. 3, 2025

(54) SECONDARY BATTERY AND ELECTRONIC APPARATUS

(71) Applicant: Ningde Amperex Technology Limited, Ningde (CN)

(72) Inventors: Nan CHU, Ningde (CN); Zuzhen GONG, Ningde (CN)

(73) Assignee: Ningde Amperex Technology Limited, Ningde (CN)

(21) Appl. No.: 19/003,128

(22) Filed: Dec. 27, 2024

(30) Foreign Application Priority Data
Dec. 29, 2023 (CN) 202311866949.5

(51) Int. Cl. H01M 4/36; H01M 4/02; H01M 4/62; H01M 10/0525

(52) U.S. Cl. CPC H01M 4/366; H01M 4/622; H01M 4/625; H01M 10/0525; H01M 2004/021; H01M 2004/028

(57) ABSTRACT

An electrode assembly includes a positive electrode plate, a negative electrode plate, and a separator disposed between the positive electrode plate and the negative electrode plate; and the positive electrode plate, the negative electrode plate, and the separator are stacked. An outermost electrode plate of the electrode assembly is a single-sided positive electrode plate. The single-sided positive electrode plate includes a positive electrode current collector, a first positive electrode material layer, and a second positive electrode material layer stacked sequentially. The first positive electrode material layer is located between the positive electrode current collector and the second positive electrode material layer. The second positive electrode material layer is adjacent to the separator. The first positive electrode material layer includes a first positive electrode active substance, a first binder, and a first conductive agent.

### CROSS-REFERENCE TO RELATED APPLICATION

The present application claims priority to Chinese Patent application No. CN 202311866949.5 filed in the China National Intellectual Property Administration on Dec. 29, 2023, the entire content of which is hereby incorporated by reference.

### TECHNICAL FIELD

This application relates to the field of electrochemical technologies, and in particular, to a secondary battery and an electronic apparatus.

### BACKGROUND

A secondary battery with a laminated structure, due to its advantages such as high energy density and good safety, has an increasingly extensive application range. To increase the energy density, an outermost electrode plate of the electrode assembly with the laminated structure is typically designed as a single-sided electrode plate. However, the single-sided electrode plate is prone to curling, leading to separator shrinkage and consequently causing short circuit issues. Additionally, the single-sided electrode plate is prone to warping during cycling, resulting in issues such as interface black spots and lithium precipitation, thus affecting the safety performance and cycling performance of the battery.

### SUMMARY

This application is intended to provide a secondary battery and an electronic apparatus to improve the safety performance and cycling performance of the secondary battery. Specific technical solutions are described below.

It should be noted that in the summary of this application, an example in which a lithium-ion battery is used as a secondary battery is used to illustrate this application. However, the secondary battery in this application is not limited to the lithium-ion battery and may alternatively be a sodium-ion battery, a lithium-sulfur battery, or the like.

According to a first aspect of this application, a secondary battery is provided, including an electrode assembly with a laminated structure. The electrode assembly includes a positive electrode plate, a negative electrode plate, and a separator disposed between the positive electrode plate and the negative electrode plate; and the positive electrode plate, the negative electrode plate, and the separator are stacked; an outermost electrode plate of the electrode assembly is a single-sided positive electrode plate; the single-sided positive electrode plate includes a positive electrode current collector, a first positive electrode material layer, and a second positive electrode material layer stacked sequentially, where the first positive electrode material layer is located between the positive electrode current collector and the second positive electrode material layer, and the second positive electrode material layer is adjacent to the separator; the first positive electrode material layer includes a first positive electrode active substance, a first binder, and a first conductive agent, where based on a mass of the first positive electrode material layer, a mass percentage of the first binder is Y₁%; the second positive electrode material layer includes a second positive electrode active substance, a second binder, and a second conductive agent, where based on a mass of the second positive electrode material layer, a mass percentage of the second binder is Y₂%; and 0<Y₂−Y₁≤1.7. When the outermost electrode plate of the secondary battery includes the first positive electrode material layer and the second positive electrode material layer, controlling the value of Y₂−Y₁ within the above range can improve an adhesion force between the outermost electrode plate and an outermost separator, avoiding the issues of separator shrinkage and warping of the outermost electrode plate during cycling, thereby improving the safety performance and cycling performance of the secondary battery.

In some embodiments of this application, 0.3≤Y₂−Y₁≤1.0, 0.5≤Y₁≤1.3, and 1.5≤Y₂≤3.0. Controlling the value of Y₂−Y₁ within the above range can better guarantee the safety performance, cycling performance, and energy density of the secondary battery. A binder in a positive electrode active substance layer mainly plays a role of bonding and forming an active substance layer and also ensures that the positive electrode active substance layer does not fall off during cycling of the secondary battery. However, the binder provides no capacity. A large amount of binder decreases the energy density of the secondary battery. Therefore, the percentages of the binders in the first positive electrode material layer and the second positive electrode material layer are preferably guaranteed within the ranges of 0.5≤Y₁≤1.3 and 1.5≤Y₂≤3.0, so that the cycling performance and the energy density can be guaranteed. In addition, if there is a small difference between the percentages of the binders in the first positive electrode material layer and the second positive electrode material layer, for example, Y₂−Y₁<0.3, the above technical effects brought by the layered arrangement of active substance layers are not very obvious. If there is a large difference between the percentages of the binders in the first positive electrode material layer and the second positive electrode material layer, for example, Y₂−Y₁>1.0, there are large differences in energy densities and adhesion forces of the first positive electrode material layer and the second positive electrode material layer, which is not conducive to the cycling performance.

In some embodiments of this application, an adhesion force N between the single-sided positive electrode plate and the separator is 15 N/m to 30 N/m. The adhesion force between the single-sided positive electrode plate and the separator being within the above range allows for a high adhesion force between the single-sided positive electrode plate and the separator, and is conducive to improving the safety performance and cycling performance of the secondary battery.

In some embodiments of this application, based on the mass of the first positive electrode material layer, a mass percentage of the first conductive agent is Z₁%; based on the mass of the second positive electrode material layer, a mass percentage of the second conductive agent is Z₂%; and 0<Z₂−Z₁≤0.5. Controlling the value of Z₂−Z₁ within the above range can guarantee the energy density of the secondary battery while improving the adhesion force between the outermost electrode plate and the outermost separator and reducing the resistance of the secondary battery.

In some embodiments of this application, 0.7≤Z₁≤2.0, and 1.2≤Z₂≤2.5. The mass percentage Z₁% of the first conductive agent in the first positive electrode material layer being within the above range is conducive to guaranteeing the energy density of the secondary battery while reducing the resistance of the secondary battery. In addition, controlling the value of the mass percentage Z₂% of the second conductive agent in the second positive electrode material layer within the above range is conducive to improving the kinetic performance and energy density of an outer layer and alleviating the issues of black spots and lithium precipitation on the outer layer during cycling.

In some embodiments of this application, a compacted density of the first positive electrode material layer is D₁, and 4.00 g/cm³≤D₁≤4.35 g/cm³; and a compacted density of the second positive electrode material layer is D₂, and 3.80 g/cm³≤D₂≤4.20 g/cm³. The compacted density of the first positive electrode material layer being within the above range is conducive to increasing the energy density of the secondary battery. In addition, controlling the compacted density of the second positive electrode material layer within the above range is conducive to guaranteeing the energy density of the secondary battery while improving the adhesion force between the outermost electrode plate and the outermost separator.

In some embodiments of this application, the secondary battery satisfies at least one of the following characteristics:
(1) a thickness T₂ of the second positive electrode material layer is 2 μm to 20 μm;
(2) a thickness T₁ of the first positive electrode material layer is 20 μm to 100 μm; or
(3) a thickness T₀ of the positive electrode current collector is 5 μm to 15 μm.

The secondary battery satisfying at least one of the above characteristics is conducive to guaranteeing the energy density of the secondary battery while improving the adhesion force between the outermost electrode plate and the outermost separator.

In some embodiments of this application, the first binder and the second binder each independently include at least one of polyacrylate ester, polyimide, polyamide, polyamideimide, poly(vinylidene difluoride), styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose. The types of the first binder and the second binder being within the above range is conducive to improving the adhesion force between the outermost electrode plate and the outermost separator.

In some embodiments of this application, the first conductive agent and the second conductive agent each independently include at least one of conductive carbon black, carbon nanotubes, carbon fiber, or graphene. The types of the first conductive agent and the second conductive agent being within the above range is conducive to reducing the resistance of the secondary battery.

According to a second aspect of this application, an electronic apparatus is provided, including the secondary battery according to any one of the foregoing embodiments.

The beneficial effects of this application are described below.

This application provides a secondary battery and an electronic apparatus. The secondary battery includes an electrode assembly with a laminated structure. The electrode assembly includes a positive electrode plate, a negative electrode plate, and a separator disposed between the positive electrode plate and the negative electrode plate; and the positive electrode plate, the negative electrode plate, and the separator are stacked. An outermost electrode plate of the electrode assembly is a single-sided positive electrode plate. The single-sided positive electrode plate includes a positive electrode current collector, a first positive electrode material layer, and a second positive electrode material layer stacked sequentially. The first positive electrode material layer is located between the positive electrode current collector and the second positive electrode material layer. The second positive electrode material layer is adjacent to the separator. The first positive electrode material layer includes a first positive electrode active substance, a first binder, and a first conductive agent, where based on a mass of the first positive electrode material layer, a mass percentage of the first binder is Y₁%; the second positive electrode material layer includes a second positive electrode active substance, a second binder, and a second conductive agent, where based on a mass of the second positive electrode material layer, a mass percentage of the second binder is Y₂%; and 0<Y₂−Y₁≤1.7. The secondary battery provided in this application has good safety performance and cycling performance.

Certainly, when any product or method of this application is implemented, all advantages described above are not necessarily demonstrated simultaneously.

### BRIEF DESCRIPTION OF DRAWINGS

To describe the technical solutions in some embodiments of this application or the prior art more clearly, the following briefly describes the accompanying drawings required for describing some embodiments or the prior art. Apparently, the accompanying drawings in the following description show merely some embodiments of this application, and persons of ordinary skill in the art may still derive other drawings from these accompanying drawings.

FIG. 1 is a schematic structural diagram of an electrode assembly according to some embodiments of this application;

FIG. 2 is a schematic cross-sectional structural diagram of an electrode assembly along its thickness direction according to some embodiments of this application; and

FIG. 3 is a schematic cross-sectional structural diagram of a single-sided positive electrode plate along its thickness direction in FIG. 2.

Reference signs in the drawings are as follows: 1. electrode assembly; 10. double-sided positive electrode plate; 11. single-sided positive electrode plate; 20. separator; 30. negative electrode plate; 101. positive electrode current collector; 102. first positive electrode material layer; and 103. second positive electrode material layer.

### DESCRIPTION OF EMBODIMENTS

The following clearly and completely describes the technical solutions in some embodiments of this application with reference to the accompanying drawings in these embodiments of this application. Apparently, the described embodiments are only some rather than all of these embodiments of this application. All other embodiments obtained by persons skilled in the art based on this application shall fall within the protection scope of this application.

It should be noted that in specific embodiments of this application, an example in which a lithium-ion battery is used as a secondary battery is used to illustrate this application. However, the secondary battery in this application is not limited to the lithium-ion battery and may alternatively be a sodium-ion battery, a lithium-sulfur battery, or the like.

At present, an outermost electrode plate of an electrode assembly with a laminated structure is typically a single-sided positive electrode plate. Only one side of a positive electrode current collector is provided with a positive electrode material layer, leading to uneven stress on two sides of the positive electrode current collector and making the positive electrode current collector be prone to curling. Additionally, the single-sided electrode plate is prone to warping during cycling, thus affecting the safety performance and cycling performance of a battery. In view of the above issues, the main solutions at present are as follows: A ceramic layer is provided on an outer side of the single-sided positive electrode plate, which can partially alleviate the issue of uneven stress on two sides. However, this solution requires an additional step of applying the ceramic layer, resulting in high costs; and the curling of the electrode plate still occurs. Alternatively, an outermost positive electrode plate is arranged as a double-sided positive electrode plate, which can effectively alleviate the issue of uneven stress. However, this solution involves complex processes and high costs. In addition, an outermost active substance layer occupies space and provides no capacity, so that the energy density is significantly decreased, and the issue of curling can not be completely addressed. Therefore, this application provides a secondary battery, which can address the issues of curling and warping of the outermost electrode plate being the single-sided positive electrode plate, thereby improving the safety performance and cycling performance of the secondary battery.

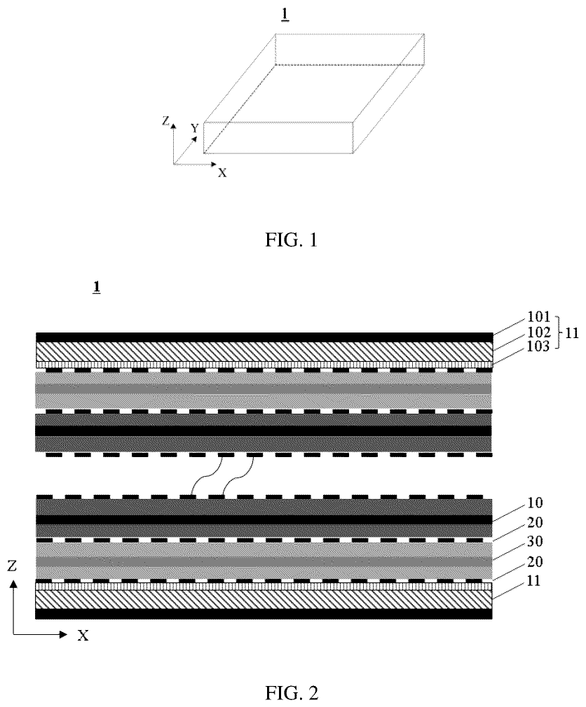

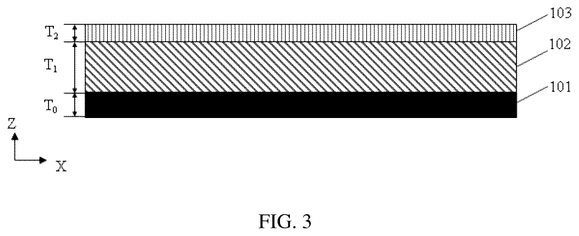

According to a first aspect of this application, a secondary battery is provided, including an electrode assembly 1 with a laminated structure. As shown in FIG. 1, for ease of understanding, a three-dimensional rectangular coordinate system is established by taking a width direction of the electrode assembly 1 as a direction X, a length direction of the electrode assembly 1 as a direction Y, and a thickness direction of the electrode assembly 1 as a direction Z. As shown in FIG. 2 and FIG. 3, the electrode assembly 1 includes a positive electrode plate, a negative electrode plate 30, and a separator 20 disposed between the positive electrode plate and the negative electrode plate 30; and the positive electrode plate, the negative electrode plate 30, and the separator 20 are stacked. The positive electrode plate includes a double-sided positive electrode plate 10 and a single-sided positive electrode plate 11. An outermost electrode plate of the electrode assembly 1 is a single-sided positive electrode plate 11. The single-sided positive electrode plate 11 includes a positive electrode current collector 101, a first positive electrode material layer 102, and a second positive electrode material layer 103 stacked sequentially, where the first positive electrode material layer 102 is located between the positive electrode current collector 101 and the second positive electrode material layer 103, and the second positive electrode material layer 103 is adjacent to the separator 20. The first positive electrode material layer 102 includes a first positive electrode active substance, a first binder, and a first conductive agent, where based on a mass of the first positive electrode material layer 102, a mass percentage of the first binder is Y₁%; the second positive electrode material layer 103 includes a second positive electrode active substance, a second binder, and a second conductive agent, where based on a mass of the second positive electrode material layer 103, a mass percentage of the second binder is Y₂%; and 0<Y₂−Y₁≤1.7. In some embodiments of this application, 0.3≤Y₂−Y₁≤1.0. For example, the value of Y₂−Y₁ may be 0.1, 0.3, 0.5, 0.7, 0.9, 1.0, 1.1, 1.3, 1.5, or 1.7, or falls within a range defined by any two of these values.

The inventors have found that when the outermost electrode plate includes the first positive electrode material layer and the second positive electrode material layer, and the mass percentage of the second binder in the second positive electrode material layer is greater than the mass percentage of the first binder in the first positive electrode material layer, an adhesion force between the outermost electrode plate and an outermost separator can be increased. This can avoid the issue of curling of the outermost electrode plate, reduce the risk of separator shrinkage causing short circuit, and improve the safety performance of the secondary battery. In addition, this can avoid the issue of warping of the outermost electrode plate during cycling, reduce the risk of interface black spots and lithium precipitation due to gaps during cycling, and improve the cycling performance of the secondary battery. When the value of Y₂−Y₁ is excessively small, for example, the value of Y₂−Y₁ is 0, to improve the adhesion force between the outermost positive electrode plate and the separator, it is necessary to greatly increase the amount of the binder in the positive electrode material layer. In this way, the energy density is greatly decreased, and the cycling performance deteriorates. When the value of Y₂−Y₁ is excessively large, for example, the value of Y₂−Y₁ is greater than 1.7, the mass percentage of the second binder in the second positive electrode material layer is excessively high or the mass percentage of the first binder in the first positive electrode material layer is excessively low, affecting the energy density or cycling performance of the secondary battery. Thus, when the outermost electrode plate of the secondary battery includes the first positive electrode material layer and the second positive electrode material layer, controlling the value of Y₂−Y₁ within the above range can improve the adhesion force between the outermost electrode plate and the outermost separator, avoiding the issues of separator shrinkage and warping of the outermost electrode plate during cycling, thereby guaranteeing the energy density of the secondary battery while improving the safety performance and cycling performance of the secondary battery.

It should be noted that the first positive electrode material layer 102 of this application can be provided in an entire region of a surface of the positive electrode current collector 101 or in a partial region of the surface of the positive electrode current collector 101. This is not particularly limited in this application, provided that the objectives of this application can be achieved. The second positive electrode material layer 103 of this application can be provided in an entire region of a surface of the first positive electrode material layer 102 or in a partial region of the surface of the first positive electrode material layer 102. This is not particularly limited in this application, provided that the objectives of this application can be achieved.

In some embodiments of this application, 0.5≤Y₁≤1.3, and 1.5≤Y₂≤3.0. For example, the mass percentage Y₁% of the first binder in the first positive electrode material layer may be 0.5%, 0.6%, 0.7%, 0.8%, 0.9%, 1.0%, 1.1%, 1.2%, or 1.3%, or falls within a range defined by any two of these values. For example, the mass percentage Y₂% of the second binder in the second positive electrode material layer may be 1.5%, 1.7%, 1.9%, 2.1%, 2.3%, 2.5%, 2.7%, 2.9%, or 3.0%, or falls within a range defined by any two of these values. The mass percentage Y₁% of the first binder in the first positive electrode material layer being within the above range is conducive to obtaining a secondary battery with high energy density. In addition, controlling the mass percentage Y₂% of the second binder in the second positive electrode material layer within the above range is conducive to further improving the adhesion force between the outermost electrode plate and the outermost separator while guaranteeing high energy density. This is conducive to further improving the safety performance and cycling performance of the secondary battery.

In some embodiments of this application, the adhesion force N between the single-sided positive electrode plate and the separator is 15 N/m to 30 N/m. For example, the adhesion force N between the single-sided positive electrode plate and the separator may be 15 N/m, 17 N/m, 19 N/m, 20 N/m, 22 N/m, 24 N/m, 26 N/m, 28 N/m, or 30 N/m. The adhesion force between the single-sided positive electrode plate and the separator being within the above range allows for a high adhesion force between the single-sided positive electrode plate and the separator, and is conducive to improving the safety performance and cycling performance of the secondary battery.

In some embodiments of this application, based on the mass of the first positive electrode material layer, a mass percentage of the first conductive agent is Z₁%; based on the mass of the second positive electrode material layer, a mass percentage of the second conductive agent is Z₂%; and 0<Z₂−Z₁≤0.5. For example, the value of Z₂−Z₁ may be 0.1, 0.2, 0.3, 0.4, or 0.5, or falls within a range defined by any two of these values. Controlling the value of Z₂−Z₁ within the above range can guarantee the energy density of the secondary battery while improving the adhesion force between the outermost electrode plate and the outermost separator and reducing the resistance of the secondary battery.

In some embodiments of this application, 0.7≤Z₁≤2.0, and 1.2≤Z₂≤2.5. For example, the mass percentage Z₁% of the first conductive agent in the first positive electrode material layer may be 0.7%, 0.8%, 0.9%, 1.0%, 1.1%, 1.2%, 1.3%, 1.4%, 1.5%, 1.6%, 1.7%, 1.8%, 1.9%, or 2.0%, or falls within a range defined by any two of these values. For example, the mass percentage Z₂% of the second conductive agent in the second positive electrode material layer may be 1.2%, 1.5%, 1.7%, 1.9%, 2.1%, 2.3%, or 2.5%, or falls within a range defined by any two of these values. The mass percentage Y₁% of the first conductive agent in the first positive electrode material layer being within the above range is conducive to guaranteeing the energy density of the secondary battery while reducing the resistance of the secondary battery. In addition, controlling the value of the mass percentage Y₂% of the second conductive agent in the second positive electrode material layer within the above range is conducive to improving the kinetic performance and energy density of an outer layer and alleviating the issues of black spots and lithium precipitation on the outer layer during cycling.

In some embodiments of this application, based on the mass of the first positive electrode active material layer, a mass percentage of the first positive electrode active substance is X₁%; based on the mass of the second positive electrode active material layer, a mass percentage of the second positive electrode active substance is X₂%; and 0<X₁−X₂≤2.2. For example, the value of X₁−X₂ may be 0.1, 0.3, 0.5, 0.7, 0.9, 1.1, 1.3, 1.5, 1.7, 1.9, 2.1, or 2.2, or falls within a range defined by any two of these values. Controlling the value of X₁−X₂ within the above range can guarantee the energy density of the secondary battery while improving the adhesion force between the outermost electrode plate and the outermost separator.

In some embodiments of this application, 97.0≤X₁≤98.5, and 95.5≤X₂≤97.0. For example, the mass percentage X₁% of the first positive electrode active substance in the first positive electrode material layer may be 97.0%, 97.2%, 97.4%, 97.6%, 97.8%, 98.0%, 98.1%, 98.3%, or 98.5%, or falls within a range defined by any two of these values. For example, the mass percentage X₂% of the second positive electrode active substance in the second positive electrode material layer may be 95.5%, 95.7%, 95.9%, 96.1%, 96.3%, 96.5%, 96.7%, 96.9%, or 97.0%, or falls within a range defined by any two of these values. The mass percentage X₁% of the first positive electrode active substance in the first positive electrode material layer being within the above range is conducive to obtaining a secondary battery with high energy density. In addition, controlling the mass percentage X₂% of the second positive electrode active substance in the second positive electrode material layer being within the above range is conducive to guaranteeing the energy density of the secondary battery while improving the adhesion force between the outermost electrode plate and the outermost separator.

In some embodiments of this application, a compacted density of the first positive electrode material layer is D₁, and 4.00 g/cm³≤D₁≤4.35 g/cm³; and a compacted density of the second positive electrode material layer is D₂, and 3.80 g/cm³≤D₂≤4.20 g/cm³. For example, the compacted density of the first positive electrode material layer may be 4.00 g/cm³, 4.02 g/cm³, 4.04 g/cm³, 4.06 g/cm³, 4.08 g/cm³, 4.10 g/cm³, 4.12 g/cm³, 4.14 g/cm³, 4.16 g/cm³, 4.18 g/cm³, 4.20 g/cm³, 4.21 g/cm³, 4.23 g/cm³, 4.25 g/cm³, 4.27 g/cm³, 4.29 g/cm³, 4.31 g/cm³, 4.33 g/cm³, or 4.35 g/cm³, or falls within a range defined by any two of these values. For example, the compacted density of the second positive electrode material layer may be 3.80 g/cm³, 3.82 g/cm³, 3.84 g/cm³, 3.86 g/cm³, 3.88 g/cm³, 3.90 g/cm³, 3.92 g/cm³, 3.94 g/cm³, 3.96 g/cm³, 3.98 g/cm³, 4.00 g/cm³, 4.02 g/cm³, 4.04 g/cm³, 4.06 g/cm³, 4.08 g/cm³, 4.10 g/cm³, 4.12 g/cm³, 4.14 g/cm³, 4.16 g/cm³, 4.18 g/cm³, or 4.20 g/cm³, or falls within a range defined by any two of these values. The compacted density of the first positive electrode material layer being within the above range is conducive to increasing the energy density of the secondary battery. In addition, controlling the compacted density of the second positive electrode material layer within the above range is conducive to guaranteeing the energy density of the secondary battery while improving the adhesion force between the outermost electrode plate and the outermost separator.

In some embodiments of this application, as shown in FIG. 3, a thickness T₂ of the second positive electrode material layer 103 is 2 μm to 20 μm. For example, the thickness of the second positive electrode material layer may be 2 μm, 3 μm, 4 μm, 5 μm, 6 μm, 7 μm, 8 μm, 9 μm, 11 μm, 13 μm, 15 μm, 17 μm, 18 μm, or 20 μm, or falls within a range defined by any two of these values. The thickness of the second positive electrode material layer being within the above range is conducive to guaranteeing the energy density of the secondary battery while improving the adhesion force between the outermost electrode plate and the outermost separator.

In some embodiments of this application, as shown in FIG. 3, a thickness T₁ of the first positive electrode material layer 102 is 20 μm to 100 μm. For example, the thickness of the first positive electrode material layer may be 20 μm, 24 μm, 28 μm, 30 μm, 31 μm, 32 μm, 33 μm, 34 μm, 35 μm, 36 μm, 37 μm, 38 μm, 39 μm, 45 μm, 55 μm, 65 μm, 75 μm, 85 μm, 95 am, or 100 μm, or falls within a range defined by any two of these values. The thickness of the first positive electrode material layer being within the above range is conducive to increasing the energy density of the secondary battery.

In some embodiments of this application, as shown in FIG. 3, a thickness T₀ of the positive electrode current collector 101 is 5 μm to 15 μm. For example, the thickness of the positive electrode current collector may be 5 μm, 6 μm, 7 μm, 8 μm, 8.5 μm, 9 μm, 9.5 μm, 10 μm, 11 μm, 13 μm, 14 μm, or 15 μm, or falls within a range defined by any two of these values. In this application, increasing the mass percentage of the second binder in the second positive electrode material layer can improve the adhesion force between the outermost electrode plate and the outermost separator, making a thinner positive electrode current collector less prone to breakage, thus meeting the safety performance of the battery, and helping to expand an application range of a thin substrate. The thickness of the positive electrode current collector being within the above range is conducive to increasing the energy density of the secondary battery while ensuring that the positive electrode current collector is not prone to breakage.

In some embodiments of this application, the first binder and the second binder each independently include at least one of polyacrylate ester, polyimide, polyamide, polyamideimide, poly(vinylidene difluoride) (PVDF), styrene-butadiene rubber (SBR), sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose. The types of the first binder and the second binder of this application may be the same or different. The types of the first binder and the second binder being within the above range is conducive to improving the adhesion force between the outermost electrode plate and the outermost separator.

In some embodiments of this application, the first conductive agent and the second conductive agent each independently include at least one of conductive carbon black (Super P, abbreviated as SP), carbon nanotubes (CNTs), carbon fiber, or graphene. The carbon nanotubes may include but are not limited to single-walled carbon nanotubes and/or multi-walled carbon nanotubes. The carbon fiber may include but is not limited to vapor grown carbon fiber (VGCF) and/or carbon nanofiber. The types of the first conductive agent and the second conductive agent of this application may be the same or different. The types of the first conductive agent and the second conductive agent being within the above range is conducive to reducing the resistance of the secondary battery.

In some embodiments of this application, the first positive electrode active substance and the second positive electrode active substance each independently include at least one of lithium cobaltate, lithium manganate, lithium nickelate, lithium iron phosphate, lithium manganese iron phosphate, lithium vanadium phosphate, lithium vanadium oxide phosphate, a lithium-rich manganese-based material, lithium nickel cobalt manganate, lithium nickel cobalt aluminate, or lithium titanate. The types of the first positive electrode active substance and the second positive electrode active substance of this application may be the same or different. The types of the first positive electrode active substance and the second positive electrode active substance being within the above range is conducive to increasing the energy density of the secondary battery.

In some embodiments of this application, at 85° C. and 1.8 MPa, the electrode assembly is hot pressed, an overall compression ratio of the single-sided positive electrode plate and the outermost separator is less than or equal to 10%, and an overall compression thickness of the single-sided positive electrode plate and the outermost separator is less than or equal to 1 μm. The overall compression ratio of this application refers to a ratio of the overall compression thickness of the outermost electrode plate and the outermost separator to a total thickness of the outermost electrode plate and the outermost separator before hot pressed.

A preparation method of the single-sided positive electrode plate is not particularly limited in this application, provided that the objectives of this application can be achieved. For example, the single-sided positive electrode plate can be prepared in the following steps: The first positive electrode active substance, the first binder, the first conductive agent, and a solvent are stirred well at a specified ratio to form a stable first positive electrode slurry. The second positive electrode active substance, the second binder, the second conductive agent, and a solvent are stirred well at a certain ratio to form a stable second positive electrode slurry. The first positive electrode slurry is uniformly applied on a surface of the positive electrode current collector facing the interior of the electrode assembly and then dried. Then, the second positive electrode slurry is applied on the surface of the first positive electrode material layer and then dried. Then, the single-sided positive electrode plate is obtained. For example, the single-sided positive electrode plate can be prepared in the following steps: The first positive electrode active substance, the first binder, the first conductive agent, and a solvent are stirred well at a specified ratio to form a stable first positive electrode slurry. The second positive electrode active substance, the second binder, the second conductive agent, and a solvent are stirred at a specified ratio to form a stable second positive electrode slurry. The first positive electrode slurry and the second positive electrode slurry are applied simultaneously using a double-layer coating method, so that the first positive electrode material layer is located between the positive electrode current collector and the second positive electrode material layer. Then, drying is performed, and the single-sided positive electrode plate is obtained. The type and amount of the solvent used are not particularly limited in this application, provided that the objectives of this application can be achieved. For example, the solvent is selected from N-methylpyrrolidone.

In this application, the features in any of the above embodiments can be combined, and the combined embodiments also fall within the protection scope of this application.

In some embodiments of this application, the double-sided positive electrode plate includes a positive electrode current collector and positive electrode material layers provided on two surfaces of the positive electrode current collector. It should be noted that the “surface” herein may be an entire region of the surface of the positive electrode current collector or a partial region of the surface of the positive electrode current collector. This is not particularly limited in this application, provided that the objectives of this application can be achieved. The positive electrode material layer includes a positive electrode active substance, a binder, and a conductive agent. The types of the positive electrode active substance, the binder, and the conductive agent are not particularly limited in this application, provided that the objectives of this application can be achieved. For example, the positive electrode active substance may be selected from at least one of the foregoing first positive electrode active substance or second positive electrode active substance. The binder may be selected from at least one of the foregoing first binder or second binder. The conductive agent may be selected from at least one of the foregoing first conductive agent or second conductive agent. A mass ratio of the positive electrode active substance, binder, and conductive agent in the positive electrode material layer is not particularly limited in this application and can be chosen by persons skilled in the art based on actual needs, provided that the objectives of this application can be achieved.

The thickness of the positive electrode material layer is not particularly limited in this application, provided that the objectives of this application can be achieved. For example, the thickness of the positive electrode material layer is 22 μm to 120 μm. The positive electrode current collector is not particularly limited in this application, provided that the objectives of this application can be achieved. For example, the positive electrode current collector may include an aluminum foil, an aluminum alloy foil, or a composite current collector (for example, an aluminum-carbon composite current collector).

The thickness of the positive electrode current collector is not particularly limited in this application, provided that the objectives of this application can be achieved. For example, the thickness of the positive electrode current collector is 5 μm to 15 μm.

The thickness of the double-sided positive electrode plate is not particularly limited in this application, provided that the objectives of this application can be achieved. For example, the thickness of the double-sided positive electrode plate is 40 μm to 250 μm.

In this application, the negative electrode plate includes a negative electrode current collector and a negative electrode material layer provided on at least one surface of the negative electrode current collector. The “negative electrode material layer being provided on at least one surface of the negative electrode current collector” means that the negative electrode material layer may be provided on one surface of the negative electrode current collector in its thickness direction or on two surfaces of the negative electrode current collector in its thickness direction. It should be noted that the “surface” herein may be an entire region of the surface of the negative electrode current collector or a partial region of the surface of the negative electrode current collector. This is not particularly limited in this application, provided that the objectives of this application can be achieved.

The negative electrode current collector is not particularly limited in this application, provided that the objectives of this application can be achieved. For example, the negative electrode current collector may include a copper foil, a copper alloy foil, a nickel foil, a stainless steel foil, a titanium foil, nickel foam, copper foam, or a composite current collector (for example, a lithium-copper composite current collector, a carbon-copper composite current collector, a nickel-copper composite current collector, or a titanium-copper composite current collector).

The negative electrode material layer includes a negative electrode active material. The negative electrode active material is not particularly limited in this application, provided that the objectives of this application can be achieved. For example, the negative electrode active material may include but is not limited to at least one of natural graphite, artificial graphite, mesocarbon microbeads, hard carbon, soft carbon, silicon, silicon-carbon composite, Li—Sn alloy, Li—Sn—O alloy, Sn, SnO, SnO₂, spinel-structured lithiated TiO₂—Li₄Ti₅O₁₂, or Li—Al alloy.

The negative electrode material layer may further include a conductive agent and a binder. The types of the conductive agent and the binder are not particularly limited in this application, provided that the objectives of this application can be achieved. For example, the conductive agent may be selected from at least one of the foregoing first conductive agent or second conductive agent, and the binder may be selected from at least one of the foregoing first binder and second binder. A mass ratio of the negative electrode active material, conductive agent, and binder in the negative electrode material layer is not particularly limited in this application and can be chosen by persons skilled in the art based on actual needs, provided that the objectives of this application can be achieved.

The negative electrode material layer further includes a conductive agent and a thickener. The types of the conductive agent and the thickener are not particularly limited in this application, provided that the objectives of this application can be achieved. For example, the conductive agent may be selected from at least one of the foregoing first conductive agent or second conductive agent. The thickener may include but is not limited to at least one of sodium carboxymethyl cellulose (CMC—Na) or lithium carboxymethyl cellulose (CMC—Li). A mass ratio of the negative electrode active material, conductive agent, binder, and thickener in the negative electrode material layer is not particularly limited in this application and can be chosen by persons skilled in the art based on actual needs, provided that the objectives of this application can be achieved.

The thickness of the negative electrode material layer is not particularly limited in this application, provided that the objectives of this application can be achieved. For example, the thickness of the negative electrode material layer is 30 μm to 120 μm. The thickness of the negative electrode current collector is not particularly limited in this application, provided that the objectives of this application can be achieved. For example, the thickness of the negative electrode current collector is 4 μm to 12 μm. The thickness of the negative electrode plate is not particularly limited in this application, provided that the objectives of this application can be achieved. For example, the thickness of the negative electrode plate is 50 μm to 250 μm.

Optionally, the negative electrode plate may further include a conductive layer, and the conductive layer is located between the negative electrode current collector and the negative electrode material layer. The composition of the conductive layer is not particularly limited in this application, and the conductive layer may be a conductive layer commonly used in the art. For example, the conductive layer includes a conductive agent and a binder. The conductive agent and binder in the conductive layer are not particularly limited in this application, and may be, for example, at least one of the foregoing conductive agents and binders.

In this application, the separator is used to separate the positive electrode plate from the negative electrode plate, prevent internal short circuits in an electrochemical apparatus, allow free passage of electrolyte ions, and not affect the electrochemical charging and discharging process. The separator is not particularly limited in this application, provided that the objectives of this application can be achieved. For example, the material of the separator may include but is not limited to at least one of polyethylene (PE) and polypropylene (PP)-based polyolefin (PO), polyester (for example, a polyethylene terephthalate (PET) film), cellulose, polyimide (PI), polyamide (PA), spandex, or aramid. The type of the separator may include at least one of a woven film, a nonwoven film, a microporous film, a composite film, a laminated film, or a spinning film.

In some embodiments of this application, the separator may include a substrate layer and a surface treatment layer. The substrate layer may be a non-woven fabric, film, or composite film having a porous structure, and the material of the substrate layer may include at least one of polyethylene, polypropylene, polyethylene glycol terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is provided on at least one surface of the substrate layer, and the surface treatment layer may be a polymer layer, an inorganic substance layer, or a layer formed by a mixture of a polymer and an inorganic substance.

For example, the inorganic substance layer includes inorganic particles and a binder. The inorganic particles are not particularly limited. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited. For example, the binder may be at least one of the foregoing binders. The polymer layer includes a polymer. The material of the polymer includes at least one of polyamide, polyacrylonitrile, an acrylate ester polymer, polyacrylic acid, polyacrylate salt, polyvinylpyrrolidone, polyvinyl ether, polyvinylidene fluoride, or poly(vinylidene fluoride-hexafluoropropylene).

In this application, the secondary battery further includes an electrolyte solution. The electrolyte solution includes a lithium salt and other non-aqueous solvents.

The lithium salt is not particularly limited in this application, provided that the objectives of this application can be achieved. For example, the lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, lithium bis(oxalato)borate (LiBOB), or lithium difluoroborate. The concentration of the lithium salt in the electrolyte solution is not particularly limited in this application, provided that the objectives of this application can be achieved.

The non-aqueous solvent is not particularly limited in this application, provided that the objectives of this application can be achieved. For example, the non-aqueous solvent may include but is not limited to at least of a carbonate compound, a carboxylate compound, an ether compound, or another organic solvent. A mass percentage of the non-aqueous solvent in the electrolyte solution is not particularly limited in this application, provided that the objectives of this application can be achieved.

The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonate may include but is not limited to at least one of ethylene carbonate (EC), propylene carbonate (PC), butylene carbonate (BC), vinylene carbonate (VC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate.

The carboxylate compound may include but is not limited to at least one of methyl formate, methyl acetate, ethyl acetate, n-propyl acetate, tert-butyl acetate, methyl propionate, ethyl propionate, propyl propionate (PP), γ-butyrolactone, decalactone, valerolactone, or caprolactone. The ether compound may include but is not limited to at least one of dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran.

The another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery in this application further includes a packaging bag for accommodating the positive electrode plate, the separator, the negative electrode plate, the electrolyte solution, and another component of the secondary battery known in the art. The another component is not limited in this application. The packaging bag is not particularly limited in this application and may be a packaging bag well known in the art, provided that the objectives of this application can be achieved.

A preparation process of the secondary battery in this application is well known to persons skilled in the art and is not particularly limited in this application. For example, the preparation process may include but is not limited to the following steps: The positive electrode plate, the separator, and the negative electrode plate are stacked sequentially, where the positive electrode plate includes a single-sided positive electrode plate and a double-sided positive electrode plate, an outermost positive electrode plate is the single-sided positive electrode plate and the remaining positive electrode plate is the double-sided positive electrode plate. Then, four corners of an entire laminated structure are fastened by an adhesive tape to obtain an electrode assembly with the laminated structure. The electrode assembly is put into the packaging bag. The electrolyte solution is injected into the packaging bag, and sealing is performed. Then, the secondary battery is obtained. In addition, an overcurrent prevention element, a guide plate, and the like may also be placed in the packaging bag based on needs, so as to prevent pressure increase, overcharge, and overdischarge in the secondary battery.

According to a second aspect, an electronic apparatus is provided, including the secondary battery according to any one of the foregoing embodiments. Therefore, the electronic apparatus provided in this application has good use performance.

The type of the electronic apparatus is not particularly limited in this application, and the electronic apparatus may be any electronic apparatus known in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, and a lithium-ion capacitor.

### EXAMPLES

The following describes some embodiments of this application more specifically by using examples and comparative examples. Various tests and evaluations are performed in the following methods. In addition, unless otherwise specified, “part” and “%” are based on mass.

### Test Methods and Equipment:

### Adhesion Force N Test:

A dry-pressing adhesion force between the separator and the positive electrode plate was tested with reference to the 180° peel test standard. The lithium-ion battery in each of the tested examples and comparative examples was disassembled, the negative electrode plate was peeled off, and the separator and the positive electrode plate were soaked in dimethyl ether carbonate for 20 min to remove the electrolyte solution. Then, the separator and the positive electrode plate were laminated and hot pressed for 85 s at 85° C. under 1 MPa using a hot pressing machine. A laminated sample was cut into small strips with a size of 15 mm×30 mm. A test sample strip for testing the adhesion force between the separator and the positive electrode plate was obtained. A double-sided adhesive tape (NITTO.NO5000NS) with a size of 15 mm×35 mm was adhered to a steel plate, and then the test sample strip was adhered to the double-sided adhesive tape with a test surface facing down. A paper tape with a size of 15 mm×50 mm was connected to one end of the test sample strip via the double-sided adhesive tape, and a small stick with a mass of 2 kg was manually rolled over the test sample strip 8 times to obtain a test sample. The test was conducted using a tensile testing machine. The test sample was fastened on a test bench, the paper tape was flipped upwards by 180° and fastened using a fixture, and then a tensile testing machine started pulling the paper tape at a speed of 50 mm/min. The test ended after the separator and the positive electrode plate on the surface of the double-sided adhesive tape were separated; and test data was stored. The adhesion force N between the separator and the positive electrode plate was calculated based on a tensile force and a tensile displacement obtained when the separator and the positive electrode plate were separated, where the adhesion force N was measured in N/m.

### Compacted Density Test:

A positive electrode current collector with an area of S was weighed using an electronic balance, and the weight was recorded as W₀; and a thickness T₀ of the positive electrode current collector was measured using a micrometer. A first positive electrode material layer was formed on a surface of the positive electrode current collector by coating and cold pressing and weighed using the electronic balance, and the weight was recorded as W₁₀; and a total thickness T₁₀ was measured using the micrometer. A second positive electrode material layer was formed on the surface of the first positive electrode material layer by coating and cold pressing and weighed using the electronic balance, and the weight was recorded as W₂₀; and a total thickness T₂₀ was measured using the micrometer. A weight W₁ and thickness T₁ of the first positive electrode material layer on a side of the positive electrode current collector and a compacted density D₁ of the first positive electrode material layer, a weight W₂ and thickness T₂ of the second positive electrode material layer, and a compacted density D₂ of the second positive electrode material layer were calculated using the following formula: W₁=W₁₀−W₀, and T₁=T₁₀−T₀, so that the compacted density D₁=W₁/(T₁×S); and W₂=W₂₀−W₁₀, and T₂=T₂₀−T₁₀, so that the compacted density D₂=W₂/(T₂×S).

### Thickness Swelling Rate Test:

The lithium-ion battery was charged at a constant current of 0.5 C to 3.95 V, and an initial half-charged state was obtained. A thickness of the lithium-ion battery in the initial half-charged state was measured as H₀ using a spiral micrometer. After 800 cycles of the above cycling performance test process, the lithium-ion battery was charged at a constant current of 0.5 C to a full-charge voltage of 4.45 V, and a fully charged state was obtained. A thickness of the lithium-ion battery at that point was measured as H₁ using the spiral micrometer. Thickness swelling rate after 800 cycles=(H₁−H₀)/H₀×100%.

### Drop Pass Rate Test:

The lithium-ion battery was pretreated at 25° C. After the lithium-ion battery was left standing for 60 min at room temperature, a voltage and a capacity were tested. Then, the battery was put into a special fixture and subjected to a free drop from a height of 1.5 μm from the ground according to the following sequence using special drop equipment: head-tail-head right corner-tail right corner-head left corner-tail left corner (at an angle of 45±15°). That process was repeated for 6 rounds. 100 batteries were tested. After the drop test ended, a voltage and capacity of the battery were measured and recorded, and the appearance was checked and photographed before and after the test.

Judgment criteria was as follows: no fire, no explosion, no rupture, no smoke, no electrolyte solution leakage, and voltage drop in 24 h after test<30 mV.

Drop test pass rate=the number of batteries passed drop test/the total number of batteries.

### Lithium Precipitation Performance Test:

The lithium-ion battery in each of the examples and comparative examples was placed in a 10° C. thermostat for 30 minutes, then charged to 4.2 V at a constant current of 2 C, charged to a current of 0.05 C at a constant voltage of 4.2 V, left standing for 5 minutes, and then discharged to 2.5 V at a constant current of 0.5 C. This was as one cycle. After 10 cycles of the above charging and discharging process, the battery was charged to 4.2 V at a constant current of 2 C. Then, the lithium-ion battery was disassembled to observe a lithium precipitation state on the surface of the negative electrode plate, where a region without lithium precipitation on the surface of the negative electrode plate was golden yellow, and a region with lithium precipitation was gray-white.

The degree of lithium precipitation of the lithium-ion battery was judged according to the following criteria: a lithium precipitation area being 0% indicated no lithium precipitation, a lithium precipitation area being less than or equal to 2% indicated mild lithium precipitation, a lithium precipitation area being 2% to 20% indicated moderate lithium precipitation, and a lithium precipitation area being greater than 20% indicated severe lithium precipitation, where the percentage of the lithium precipitation area was calculated based on a total area of the negative electrode material layer.

### Black Spot Test:

The lithium-ion battery was placed in a 0° C. thermostat and left standing for 60 min, so that the lithium-ion battery reached a constant temperature. At 0° C., the lithium-ion battery that had reached a constant temperature was charged at a constant current of 1 C to a full-charge voltage of 4.45 V, charged to 0.025 C at the constant voltage of 4.45 V, left standing for 5 min, and then discharged to 3.0 V at a constant current of 1 C. This process was used as one charge-discharge cycle. After 500 charge-discharge cycles, the lithium-ion battery was charged at a constant current of 1 C to the full-charge voltage of 4.45 V and then charged to 0.025 C at the constant voltage of 4.45 V. A fully charged battery after 500 cycles was obtained. The battery was disassembled in a dry room with humidity less than 5%, and photographs were taken to record whether black spots appeared at the corner interface of the negative electrode plate.

The degree of the black spots in the lithium-ion battery was judged according to the following criteria: a black spot area being 0% indicated no black spot, a black spot area being less than or equal to 2% indicated mild black spots, a black spot area being 2% to 20% indicated moderate black spots, and a black spot area being greater than 20% indicated severe black spots, where the percentage of the black spot area was calculated based on the area of the negative electrode plate.

### Energy Density Test:

The lithium-ion battery was placed in a 25° C. thermostat and left standing for 30 minutes, so that the lithium-ion battery reached a constant temperature. The lithium-ion battery that had reached a constant temperature was charged at a constant current of 0.5 C to a full-charge voltage of 4.4 V, then charged at the constant voltage of 4.4 V to a current of 0.05 C, and then discharged at a current of 0.5 C to a voltage of 3.0 V. Discharge energy was recorded.

Energy density=discharge energy/(length×width×thickness of the lithium-ion battery).

### Example 1-1

### <Preparation of Positive Electrode Plate>

### (1) Preparation of Single-Sided Positive Electrode Plate

A first positive electrode active substance lithium iron phosphate, a first binder poly(vinylidene difluoride) (PVDF for short, with a weight-average molecular weight of 5×10⁵), and a first conductive agent conductive carbon black (SP for short) were mixed at a mass ratio of 97.7:1.0:1.3, N-methylpyrrolidone was added, and the resulting mixture was stirred well in a vacuum mixer to obtain a first positive electrode slurry, where the first positive electrode slurry had a solid content of 75 wt %.

A second positive electrode active substance lithium iron phosphate, a second binder PVDF (with a weight-average molecular weight of 5×10⁵), and a second conductive agent SP were mixed at a mass ratio of 95.5:2.7:1.8, N-methylpyrrolidone was added, and the resulting mixture was stirred well in a vacuum mixer to obtain a second positive electrode slurry, where the second positive electrode slurry had a solid content of 75 wt %.

A uniform coating of the first positive electrode slurry with a thickness T₀ of 10 μm was formed on one surface of a positive electrode current collector aluminum foil by coating and cold pressing, and dried at 90° C. to form a first positive electrode material layer with a thickness T₁ of 40 μm and a compacted density D₁ of 4.20 g/cm³. Then, the second positive electrode slurry was applied on the surface of the first positive electrode material layer by coating and cold pressing, and dried at 90° C. to form a second positive electrode material layer with a thickness T₂ of 10 μm and a compacted density D₂ of 3.90 g/cm³. Then cutting and slitting were performed to obtain a single-sided positive electrode plate with a size of 38 mm×58 mm.

### (2) Preparation of Double-Sided Positive Electrode Plate

A positive electrode active substance lithium iron phosphate, a binder PVDF (with a weight-average molecular weight of 5×10⁵), and a conductive agent SP were mixed at a mass ratio of 97.0:1.0:2.0, N-methylpyrrolidone was added, and the resulting mixture was stirred well in a vacuum mixer to obtain a positive electrode slurry, where the positive electrode slurry had a solid content of 75 wt %. The positive electrode slurry was uniformly applied on one surface of a positive electrode current collector aluminum foil with a thickness of 10 μm, and dried at 90° C. to obtain a positive electrode plate having one surface coated with a positive electrode material layer with a thickness of 50 μm. The above steps were repeated on another surface of the positive electrode current collector aluminum foil to obtain a double-sided positive electrode plate. Then, after cold pressing, cutting, and slitting, a double-sided positive electrode plate with a size of 38 mm×58 mm was obtained.

### <Preparation of Negative Electrode Plate>

A negative electrode active material artificial graphite, a thickener sodium carboxymethyl cellulose (CMC-Na for short, with a weight-average molecular weight of 3×10⁵), and a binder styrene-butadiene rubber (SBR for short, with a weight-average molecular weight of 2×10⁵) were mixed at a mass ratio of 98:1:1, deionized water was added, and the resulting mixture was stirred well in a vacuum mixer to obtain a negative electrode slurry, where the negative electrode slurry had a solid content of 50 wt %. The negative electrode slurry was uniformly applied on one surface of a negative electrode current collector copper foil with a thickness of 6 μm, and dried at 85° C. to obtain a negative electrode plate having one surface coated with a negative electrode active material layer with a thickness of 75 μm. The above steps were repeated on another surface of the negative electrode current collector to obtain a negative electrode plate having two surfaces coated with negative electrode active material layers. Drying was performed at 85° C. for 1 h. After cold pressing, cutting, and slitting, a negative electrode plate with a size of 41 mm×61 mm was obtained.

### <Preparation of Electrolyte Solution>

EC, DEC, PC, PP, and VC were mixed at a mass ratio of 20:30:20:28:2 to obtain a non-aqueous organic solvent. Then, a lithium salt LiPF₆ and the non-aqueous organic solvent were mixed at a mass ratio of 12.5:87.5 to prepare an electrolyte solution.

### <Separator>

A porous polyethylene film with a thickness of 7 μm (provided by Celgard) was used as a separator.

### <Preparation of Lithium-Ion Battery>

The double-sided positive electrode plate and the negative electrode plate prepared above were stacked alternately, with the negative electrode plate as the start and end. The separator was placed between the double-sided positive electrode plate and the negative electrode plate. The single-sided positive electrode plate was stacked on the outermost layer of the above semi-finished electrode assembly, the second positive electrode material layer of the single-sided positive electrode plate faced the interior of the electrode assembly, four corners were fastened, and the electrode assembly was hot pressed at 85° C. and 1.8 MPa, to obtain an electrode assembly with a laminated structure. The electrode assembly had 2 single-sided positive electrode plate layers, 15 double-sided positive electrode plate layers, 16 negative electrode plate layers, and 32 separator layers.

The electrode assembly was placed into an aluminum-plastic film housing, and moisture was removed at 80° C., the prepared electrolyte solution was injected, and a lithium-ion battery was obtained through processes such as vacuum sealing, standing, formation, and degassing.

### Examples 1-2 to 1-10

These examples were the same as Example 1-1 except that the related preparation parameters were adjusted according to Table 1. The mass percentage of the first positive electrode active material X₁%=100%−Y₁%−Z₁%; and the mass percentage of the second positive electrode active material X₂%=100%−Y₂%−Z₂%.

### Examples 2-1 to 2-6

These examples were the same as Example 1-1 except that the related preparation parameters were adjusted according to Table 3.

### Comparative Example 1

This comparative example was the same as Example 1-2 except that the related preparation parameters were adjusted according to Table 1. The mass percentage of the first positive electrode active material X₁%=100%−Y₁%−Z₁%; and the mass percentage of the second positive electrode active material X₂%=100%−Y₂%−Z₂%.

### Comparative Example 2

This comparative example was the same as Example 1-1 except that no second positive electrode material layer was provided during the preparation of the single-sided positive electrode plate and T₁ was 35 μm. The mass percentage of the first positive electrode active material X₁%=100%−Y₁%−Z₁%.

### Comparative Example 3

This comparative example was the same as Example 1-8 except that no second positive electrode material layer was provided during the preparation of the single-sided positive electrode plate and T₁ was 35 μm. The mass percentage of the first positive electrode active material X₁%=100%−Y₁%−Z₁%.

### Comparative Example 4

This comparative example was the same as Example 1-9 except that no second positive electrode material layer was provided during the preparation of the single-sided positive electrode plate and T₁ was 35 μm. The mass percentage of the first positive electrode active material X₁=100%−Y₁% Z₁%.

The preparation parameters and performance parameters of examples and comparative examples were shown in Tables 1 to 3.

TABLE 1

| | Y₁ | Y₂ | Y₂ − | Z₁ | Z₂ | Z₂ − | D₁ | D₂ |
|---|---|---|---|---|---|---|---|---|
| | (%) | (%) | Y₁ (%) | (%) | (%) | Z₁ (%) | (g/cm³) | (g/cm³) |
| Example 1-1 | 1.0 | 2.7 | 1.7 | 1.3 | 1.8 | 0.5 | 4.20 | 3.90 |
| Example 1-2 | 1.0 | 2.0 | 1.0 | 1.3 | 1.8 | 0.5 | 4.20 | 4.05 |
| Example 1-3 | 1.0 | 1.6 | 0.6 | 1.3 | 1.8 | 0.5 | 4.20 | 4.10 |
| Example 1-4 | 1.0 | 1.3 | 0.3 | 1.3 | 1.8 | 0.5 | 4.20 | 4.15 |
| Example 1-5 | 1.0 | 1.1 | 0.1 | 1.4 | 1.9 | 0.5 | 4.20 | 4.18 |
| Example 1-6 | 1.0 | 2.0 | 1.0 | 1.3 | 1.6 | 0.3 | 4.20 | 4.05 |
| Example 1-7 | 1.0 | 2.0 | 1.0 | 1.3 | 1.4 | 0.1 | 4.20 | 4.05 |
| Example 1-8 | 1.0 | 2.0 | 1.0 | 1.3 | 2.0 | 0.7 | 4.20 | 4.05 |
| Example 1-9 | 1.3 | 3.0 | 1.7 | 0.7 | 1.2 | 0.5 | 4.15 | 3.85 |
| Example 1-10 | 0.5 | 1.5 | 1.0 | 2 | 2.5 | 0.5 | 4.30 | 4.12 |
| Comparative | 2.0 | 4.0 | 2.0 | 0.7 | 1.2 | 0.5 | 4.20 | 3.85 |
| example 1 | | | | | | | | |
| Comparative | 1.0 | / | / | 1.3 | / | / | 4.20 | / |
| example 2 | | | | | | | | |
| Comparative | 1.3 | / | / | 0.7 | / | / | 4.15 | / |
| example 3 | | | | | | | | |
| Comparative | 0.5 | / | / | 2.0 | / | / | 4.30 | / |
| example 4 | | | | | | | | |

Note:
“/” indicates non-existence.

TABLE 2

| | | Thickness | | | |
|---|---|---|---|---|---|
| | | swelling | Drop | | |
| | Adhesion | rate after | pass | Black spots, | Energy |
| | force N | 800 cycles | rate | lithium | density |
| | (N/m) | (%) | (%) | precipitation | (Wh/kg) |
| Example 1-1 | 25 | 7.0 | 100 | No lithium | 780 |
| | | | | precipitation, no | |
| | | | | black spot | |
| Example 1-2 | 20 | 7.4 | 100 | No lithium | 784 |
| | | | | precipitation, no | |
| | | | | black spot | |
| Example 1-3 | 18 | 7.5 | 97 | No lithium | 786 |
| | | | | precipitation, no | |
| | | | | black spot | |
| Example 1-4 | 16 | 7.6 | 87 | Mild lithium | 788 |
| | | | | precipitation, mild | |
| | | | | black spots | |
| Example 1-5 | 14 | 7.7 | 84 | Moderate lithium | 789 |
| | | | | precipitation, | |
| | | | | moderate black | |
| | | | | spots | |
| Example 1-6 | 20 | 7.4 | 100 | No lithium | 785 |
| | | | | precipitation, no | |
| | | | | black spot | |
| Example 1-7 | 20 | 7.4 | 100 | No lithium | 786 |
| | | | | precipitation, no | |
| | | | | black spot | |
| Example 1-8 | 20 | 7.4 | 100 | No lithium | 783 |
| | | | | precipitation, no | |
| | | | | black spot | |
| Example 1-9 | 29 | 6.7 | 100 | No lithium | 780 |
| | | | | precipitation, no | |
| | | | | black spot | |
| Example 1-10 | 17 | 7.6 | 97 | No lithium | 782 |
| | | | | precipitation, no | |
| | | | | black spot | |
| Comparative | 29 | 6.7 | 80 | No lithium | 775 |
| example 1 | | | | precipitation, no | |
| | | | | black spot | |
| Comparative | 12 | 9.0 | 55 | Moderate lithium | 790 |
| example 2 | | | | precipitation, | |
| | | | | moderate black | |
| | | | | spots | |
| Comparative | 16 | 8.4 | 72 | Mild lithium | 782 |
| example 3 | | | | precipitation, mild | |
| | | | | black spots | |
| Comparative | 7 | 10.6 | 15 | Severe lithium | 798 |
| example 4 | | | | precipitation, | |
| | | | | severe black spots | |

From Examples 1-1 to 1-10 and Comparative examples 1 to 4, it can be seen that the single-sided positive electrode plate includes the first positive electrode material layer and the second positive electrode material layer, and the difference (the value of Y₂−Y₁) between the mass percentage Y₂% of the second binder in the second positive electrode material layer and the mass percentage Y₁% of the first binder in the first positive electrode material layer is controlled within the range of this application. The value of Y₂−Y₁ in Comparative example 1 is not within the range of this application, and the energy density and drop pass rate of the lithium-ion battery are low. The single-sided positive electrode plate in Comparative example 2-4 includes only one positive electrode material layer, which is not within the range of this application. The thickness swelling rate after 800 cycles is high, the drop pass rate is low, and the mild or even severe black spots and lithium precipitation are present, indicating that the lithium-ion battery has poor safety performance and cycling performance. The lithium-ion batteries in these examples of this application have higher adhesion force, no black spot, no lithium precipitation, lower thickness swelling rate after 800 cycles, and higher drop pass rate, indicating that the lithium-ion batteries have better safety performance and cycling performance and high energy density.

The value of Y₂−Y₁ affects the safety performance, cycling performance, and energy density of the lithium-ion battery. From Examples 1-1 to 1-5, it can be seen that when the mass percentage of the second binder in the second positive electrode material layer is greater than the mass percentage of the first binder in the first positive electrode material layer, the adhesion force between the outermost electrode plate and the outermost separator can be improved, and the safety performance and cycling performance of the lithium-ion battery can be improved. In Example 1-5, the value of Y₂−Y₁ is small, the adhesion force between the outermost electrode plate and the outermost separator is less improved, the moderate black spots and moderate lithium precipitation are present, the thickness swelling rate after 800 cycles is high, and the drop pass rate is low. In Example 1-1, the value of Y₂−Y₁ is large, and the energy density of the lithium-ion battery is decreased. In Comparative example 1, the value of Y₂−Y₁ is not within the range of this application, and the energy density of the lithium-ion battery is further decreased.

The mass percentage Y₂% of the second binder in the second positive electrode material layer and the mass percentage Y₁% of the first binder in the first positive electrode material layer affect the safety performance, cycling performance, and energy density of the lithium-ion battery. From Examples 1-1, 1-2, 1-9, and 1-10, it can be seen that the value of the mass percentage Y₂% of the second binder in the second positive electrode material layer and the value of the mass percentage Y₁% of the first binder in the first positive electrode material layer are within the above range. The lithium-ion battery has high adhesion force, no black spot, no lithium precipitation, low thickness swelling rate after 800 cycles, and high drop pass rate, indicating that the lithium-ion battery has good safety performance and cycling performance and high energy density.

The difference (the value of Z₂−Z₁) between the mass percentage of the second conductive agent in the second positive electrode material layer and the mass percentage of the first conductive agent in the first positive electrode material layer affects the safety performance, cycling performance, and energy density of the lithium-ion battery. From Examples 1-2, 1-6, 1-7, and 1-8, it can be seen that when the mass percentage of the second conductive agent in the second positive electrode material layer is greater than the mass percentage of the first conductive agent in the first positive electrode material layer, the adhesion force between the outermost electrode plate and the outermost separator can be improved, and the resistance of the lithium-ion battery can be reduced. The lithium-ion battery has high adhesion force, no black spot, no lithium precipitation, low thickness swelling rate after 800 cycles, and drop pass rate of 100%, indicating that the lithium-ion battery has good safety performance and cycling performance and high energy density. In addition, in Example 1-8, the value of Z₂−Z₁ is large, and the energy density is low.

The mass percentage Z₂% of the second conductive agent in the second positive electrode material layer and the mass percentage Z₁% of the first conductive agent in the first positive electrode material layer affect the safety performance, cycling performance, and energy density of the lithium-ion battery. From Examples 1-2, 1-9, and 1-10, it can be seen that the value of the mass percentage Z₂% of the second conductive agent in the second positive electrode material layer and the mass percentage Z₁% of the first conductive agent in the first positive electrode material layer are within the above range. The lithium-ion battery has high adhesion force, no black spot, no lithium precipitation, low thickness swelling rate after 800 cycles, and high drop pass rate, indicating that the lithium-ion battery has good safety performance and cycling performance and high energy density.

TABLE 3

| | | | | | Thickness | | | |
|---|---|---|---|---|---|---|---|---|
| | | | | | swelling | | | |
| | | | | | rate after | Drop | | |
| | | | | Adhesion | 800 | pass | Black spots, | |
| | T₀ | T₁ | T₂ | force N | cycles | rate | lithium | Energy density |
| | (μm) | (μm) | (μm) | (N/m) | (%) | (%) | precipitation | (Wh/Kg) |
| Example 1-1 | 10 | 40 | 10 | 25 | 7 | 100 | No lithium | 780 |
| | | | | | | | precipitation, | |
| | | | | | | | no black spot | |
| Example 2-1 | 9 | 40 | 10 | 25 | 7 | 97 | No lithium | 783 |
| | | | | | | | precipitation, | |
| | | | | | | | no black spot | |
| Example 2-2 | 8 | 40 | 10 | 25 | 7 | 92 | No lithium | 786 |
| | | | | | | | precipitation, | |
| | | | | | | | no black spot | |
| Example 2-3 | 10 | 45 | 11 | 26 | 6.8 | 98 | No lithium | 782 |
| | | | | | | | precipitation, | |
| | | | | | | | no black spot | |
| Example 2-4 | 10 | 50 | 13 | 28 | 6.5 | 95 | Mild lithium | 785 |
| | | | | | | | precipitation, | |
| | | | | | | | mild black | |
| | | | | | | | spots | |
| Example 2-5 | 10 | 40 | 2 | 12 | 7.9 | 80 | Mild lithium | 776 |
| | | | | | | | precipitation, | |
| | | | | | | | mild black | |
| | | | | | | | spots | |
| Example 2-6 | 10 | 40 | 15 | 28 | 6.4 | 100 | No lithium | 785 |
| | | | | | | | precipitation, | |
| | | | | | | | no black spot | |

From Examples 1-1 and 2-1 to 2-6, it can be seen that the thickness T₀ of the positive electrode current collector, the thickness T₁ of the first positive electrode material layer, and the thickness T₂ of the second positive electrode material layer are within the range of this application. The lithium-ion battery has high adhesion force, no or only mild black spots and mild lithium precipitation, low thickness swelling rate after 800 cycles, and high drop pass rate, indicating that the lithium-ion battery has good safety performance and cycling performance and high energy density.

The thickness T₀ of the positive electrode current collector affects the safety performance, cycling performance, and energy density of the lithium-ion battery. From Examples 1-1, 2-1, and 2-2, it can be seen that the thickness T₀ of the positive electrode current collector is within the range of this application. The lithium-ion battery has high adhesion force, no black spots, no lithium precipitation, low thickness swelling rate after 800 cycles, and high drop pass rate, indicating that the lithium-ion battery has good safety performance and cycling performance and high energy density.

The thickness T₁ of the first positive electrode material layer affects the safety performance, cycling performance, and energy density of the lithium-ion battery. From Examples 1-1, 2-3, and 2-4, it can be seen that the thickness T₁ of the first positive electrode material layer is within the range of this application. The lithium-ion battery has high adhesion force, no or only mild black spots and mild lithium precipitation, low thickness swelling rate after 800 cycles, and high drop pass rate, indicating that the lithium-ion battery has good safety performance and cycling performance and high energy density.

The thickness T₂ of the second positive electrode material layer affects the safety performance, cycling performance, and energy density of the lithium-ion battery. From Examples 1-1, 2-5, and 2-6, it can be seen that the thickness T₂ of the second positive electrode material layer is within the range of this application. The lithium-ion battery has high adhesion force, no or only mild black spots and mild lithium precipitation, low thickness swelling rate after 800 cycles, and high drop pass rate, indicating that the lithium-ion battery has good safety performance and cycling performance and high energy density.

It should be noted that in this specification, the terms “include”, “comprise”, or any other variations thereof are intended to cover a non-exclusive inclusion, so that a process, a method, or an item including a series of elements not only includes those elements but also includes other elements that are not expressly listed, or further includes elements inherent to such process, method, or item.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising an electrode assembly having a laminated structure; wherein the electrode assembly comprises a positive electrode plate, a negative electrode plate, and a separator disposed between the positive electrode plate and the negative electrode plate; and the positive electrode plate, the negative electrode plate, and the separator are stacked;
an outermost electrode plate of the electrode assembly is a single-sided positive electrode plate;
the single-sided positive electrode plate comprises a positive electrode current collector, a first positive electrode material layer, and a second positive electrode material layer stacked sequentially, wherein the first positive electrode material layer is located between the positive electrode current collector and the second positive electrode material layer, and the second positive electrode material layer is adjacent to the separator;
the first positive electrode material layer comprises a first positive electrode active substance, a first binder, and a first conductive agent; wherein based on a mass of the first positive electrode material layer, a mass percentage of the first binder is Y₁%;
the second positive electrode material layer comprises a second positive electrode active substance, a second binder, and a second conductive agent; wherein based on a mass of the second positive electrode material layer, a mass percentage of the second binder is Y₂%; and
0<Y₂−Y₁≤1.7.

2. The secondary battery according to claim 1, wherein 0.3≤Y₂−Y₁≤1.0, 0.5≤Y₁≤1.3, and 1.5≤Y₂≤3.0.

3. The secondary battery according to claim 1, wherein an adhesion force N between the single-sided positive electrode plate and the separator is 15 N/m to 30 N/m.

4. The secondary battery according to claim 1, wherein based on the mass of the first positive electrode material layer, a mass percentage of the first conductive agent is Z₁%;
based on the mass of the second positive electrode material layer, a mass percentage of the second conductive agent is Z₂%; and
0<Z₂−Z₁≤0.5.

5. The secondary battery according to claim 4, wherein 0.7≤Z₁≤2.0, and 1.2≤Z₂≤2.5.

6. The secondary battery according to claim 1, wherein a compacted density of the first positive electrode material layer is D₁, and 4.00 g/cm³≤D₁≤4.35 g/cm³; and a compacted density of the second positive electrode material layer is D₂, and 3.80 g/cm³≤D₂≤4.20 g/cm³.

7. The secondary battery according to claim 1, wherein a thickness T₂ of the second positive electrode material layer is 2 μm to 20 μm.

8. The secondary battery according to claim 1, wherein a thickness T₁ of the first positive electrode material layer is 20 μm to 100 μm.

9. The secondary battery according to claim 1, wherein a thickness T₀ of the positive electrode current collector is 5 μm to 15 μm.

10. The secondary battery according to claim 1, wherein the first binder and the second binder each independently comprise at least one of polyacrylate ester, polyimide, polyamide, polyamideimide, poly(vinylidene difluoride), styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose.

11. The secondary battery according to claim 1, wherein the first conductive agent and the second conductive agent each independently comprise at least one of conductive carbon black, carbon nanotubes, carbon fiber, or graphene.

12. The secondary battery according to claim 1, wherein based on the mass of the first positive electrode active material layer, a mass percentage of the first positive electrode active substance is X₁%; based on the mass of the second positive electrode active material layer, a mass percentage of the second positive electrode active substance is X₂%; and 0<X₁−X₂≤2.2.

13. The secondary battery according to claim 12, wherein 97.0≤X₁≤98.5, and 95.5≤X₂≤97.0.

14. The secondary battery according to claim 1, wherein the first positive electrode active substance and the second positive electrode active substance each independently include at least one of lithium cobaltate, lithium manganate, lithium nickelate, lithium iron phosphate, lithium manganese iron phosphate, lithium vanadium phosphate, lithium vanadium oxide phosphate, a lithium-rich manganese-based material, lithium nickel cobalt manganate, lithium nickel cobalt aluminate, or lithium titanate.

15. The secondary battery according to claim 1, wherein the thickness of the positive electrode material layer is 22 μm to 120 μm.

16. The secondary battery according to claim 1, wherein the positive electrode plate includes a double-sided positive electrode plate, and the thickness of the double-sided positive electrode plate is 40 μm to 250 μm.

17. An electronic apparatus, comprising the secondary battery according to claim 1.

18. The electronic apparatus according to claim 17, wherein 0.3≤Y₂−Y₁≤1.0, 0.5≤Y₁≤1.3, and 1.5≤Y₂≤3.0.

19. The electronic apparatus according to claim 17, wherein an adhesion force N between the single-sided positive electrode plate and the separator is 15 N/m to 30 N/m.

20. The electronic apparatus according to claim 17, wherein based on the mass of the first positive electrode material layer, a mass percentage of the first conductive agent is Z₁%;
based on the mass of the second positive electrode material layer, a mass percentage of the second conductive agent is Z₂%; and
0<Z₂−Z₁≤0.5.
